(19) United States
(12) Patent Application Publication
(10) Pub. No.: US 2024/0245165 A1
(43) Pub. Date: Jul. 25, 2024

(54) MIDSOLE STRUCTURE AND MANUFACTURING METHOD THEREOF

(71) Applicant: XYZPRINTING, INC., NEW TAIPEI CITY (TW)

(72) Inventor: Rong-Qi CHEN, NEW TAIPEI CITY (TW)

(21) Appl. No.: 18/098,805

(22) Filed: Jan. 19, 2023

(51) Int. Cl. A43B 13/12; A43B 13/02; A43B 13/18

(52) U.S. Cl. CPC A43B 13/125; A43B 13/026; A43B 13/188

(57) ABSTRACT

A midsole structure includes: a body including a first surface enclosed by a first feature line, a second surface enclosed by a second feature line, and a third surface located between the first surface and the second surface and collectively enclosed by the first feature line and the second feature line; and a plurality of structure units disposed among the first surface, the second surface and the third surface. The third surface increases from a first width to a second width along a direction from a first side of the body to a second side of the body. On the first side, a first number of the structure units are arranged along the first width. On the second side, a second number of the structure units are arranged along the second width. The first width is equal to the second width.

### BACKGROUND OF THE DISCLOSURE

### Technical Field

The disclosure relates to a midsole structure and a manufacturing method thereof.

### Description of Related Art

In the related art, three-dimensional (3D) lattice structure is used to construct the midsole of the sports shoes, and different lattice structure types are applied to different areas of the midsole to generate different supporting capability. Therefore, the layers of the lattice structure in the whole midsole are not totally consistent, and the supporting hardness/softness depends on the number of frames between the connecting points. At the end, the product is manufactured by 3D printing. In another related art, the 3D lattice interweaving structure of two layers type is only disposed on the back heels of the shoes. The structure may provide the supporting capability and reaction force required when treading with the sports shoes.

Overviewing the aforementioned two structures, software is mainly used for designation, and the whole or partial midsole structure is developed according to product demand. Different types of midsoles need to be re-designed and re-developed. On the other hand, in order to generate different hardness/softness on different regions of the midsole, using different numbers of frames to generate different supporting capabilities is the main method in the related art.

However, the layers of the lattice structure in the midsole of the related art are not totally consistent. Thus, that may cause insufficient structural strength. Moreover, the related art is highly depending on designing/developing capability to further integrate the engineering application and product designation, and the development schedule for the whole product may be lengthy if the test and verification for the 3D printing material are further included.

In view of this, the inventors have devoted themselves to the aforementioned related art, and try to provide a midsole structure and a manufacturing method thereof for strengthening the structural strength, simplifying the designation, and shortening the development schedule.

### SUMMARY OF THE DISCLOSURE

The disclosure provides a midsole structure and a manufacturing method thereof, which may simplify the designation and shorten the development schedule.

The disclosure provides a midsole structure combined in a shoes product. The midsole structure includes a body and a plurality of structure units. The body includes: a first surface, enclosed by a first feature line: a second surface, enclosed by a second feature line; and a third surface, located between the first surface and the second surface, and collectively enclosed by the first feature line and the second feature line. The structure units are disposed among the first surface, the second surface, and the third surface. The third surface is increased from a first width to a second width along a direction from a first side of the body to a second side of the body. On the first side, a first number of the structure units are arranged along the first width of the third surface. On the second side, a second number of the structure units are arranged along the second width of the third surface. The first number is equal to the second number.

In some embodiments, the first feature line has a first feature point, the second feature line has a second feature point, the first feature point is corresponding to the second feature point, and the first feature point and the second feature point are distanced by the first width. The first number of the structure units are arranged between the first feature point and the second feature point.

In some embodiments, the first feature line has a third feature point, the second feature line has a fourth feature point, the third feature point is corresponding to the fourth feature point, and the third feature point and the fourth feature point are distanced by the second width. The second number of the structure units are arranged between the third feature point and the fourth feature point.

In some embodiments, each structure unit has a plurality of particles and a plurality of frames connected between the particles, the particles and the frames are structured in a 3D lattice structure.

In some embodiments, the 3D lattice structure of each structure unit arranged along the first width is corresponding to the 3D lattice structure of each structure unit arranged along the second width.

In some embodiments, each particle is a sphere, an octahedron, or a tetrahedron.

In some embodiments, a stable state of the structure units arranged along the first width is different from a stable state of the structure units arranged along the second width.

The disclosure provides a midsole structure combined in a shoes product. The midsole structure includes a body and a plurality of structure units. The body includes a first feature line and a second feature non-intersecting to each other, and an annular side surface collectively enclosed by the first feature line and the second feature line. The structure units are disposed in the body. The annular side surface has a first width and a second width, the first width is different from the second width. The structure units are arranged between the first feature line and the second feature line along the first width by a predetermined number, and the structure units are arranged between the first feature line and the second feature line along the second width by the predetermined number.

In some embodiments, the first feature line has a first feature point, the second feature line has a second feature point, the first feature point is corresponding to the second feature point, and the first feature point and the second feature point are distanced by the first width. The predetermined number of the structure units are arranged between the first feature point and the second feature point.

In some embodiments, the first feature line has a third feature point, the second feature line has a fourth feature point, the third feature point is corresponding to the fourth feature point, and the third feature point and the fourth feature point are distanced by the second width. The predetermined number of the structure units are arranged between the third feature point and the fourth feature point.

The disclosure provides a manufacturing method of a midsole structure. The manufacturing method includes: obtaining a midsole model: obtaining a first feature line and a second feature line of the midsole model: setting a structure parameter of a structure unit; computing a disposing number of the structure unit along the first feature line and the second feature line according to a length of the first feature line or the second feature line; computing a stable state of a plurality of structure units corresponding to the midsole model: arranging the structure units into the midsole model: generating the midsole structure; and manufacturing the midsole structure.

In some embodiments, the computing of the stable state of the structure units corresponding to the midsole model further includes: computing a planar stable state of the structure units corresponding to a first surface, a second surface, and a third surface located between the first surface and the second surface of the midsole model.

In some embodiments, the computing of the stable state of the structure units corresponding to the midsole model further includes: computing a 3D stable state of the structure units corresponding to the midsole model.

In some embodiments, the arranging of the structure units into the midsole model further includes: arranging the structure units into the midsole model according to the planar stable state and the 3D stable state.

In some embodiments, the computing of the 3D stable state of the structure units corresponding to the midsole model further includes: deforming the structure units on the third surface.

In some embodiments, the generating of the midsole structure further includes: modifying a plurality of structure parameters of the structure units according to a pressure distribution.

In some embodiments, the manufacturing of the midsole structure further includes: manufacturing, by 3D printing, the midsole structure.

In summary, the midsole structure and the manufacturing method thereof of the disclosure are disposing the same layers of structure units at all locations in the midsole structure. In other words, viewing the annular side surface of the midsole structure from any sides (front side, middle side or back side), on the width direction at any locations, the structure units are arranged with the same number. As a result, the whole structural strength being influenced by the incomplete structure unit may be prevented, and thus the structural strength of the midsole structure may be increased. Further, the midsole structure and the manufacturing method thereof of the disclosure are disposing the structure units into the midsole structure after computing the stable state of the structure units corresponding to the midsole model. In other words, the designer may set the structure parameters of the structure units on different regions in advance with respect to different designing requirement, and arrange the structure units into the midsole structure after computing the stable state of the structure units by software. Therefore, the midsole structure and the manufacturing method thereof of the disclosure may simplify the designation and shorten the development schedule.

### BRIEF DESCRIPTION OF THE DRAWINGS

FIG. 1A is a schematic diagram of a midsole structure of the first embodiment in the disclosure.

FIG. 1B is a schematic diagram of one side of the midsole structure of the first embodiment in the disclosure.

FIG. 2 is a schematic diagram of a structure unit of the first embodiment in the disclosure.

FIG. 3A and FIG. 3B are the schematic diagrams of the particles of different embodiments in the disclosure.

FIG. 3C and FIG. 3D are the schematic diagrams of the frames of different embodiments in the disclosure.

FIG. 4A is a schematic diagram of a midsole structure of the second embodiment in the disclosure.

FIG. 4B is a schematic diagram of one side of the midsole structure of the second embodiment in the disclosure.

FIG. 4C is a schematic diagram of a structure unit of the second embodiment in the disclosure.

FIG. 5A is a schematic diagram of a midsole structure of the third embodiment in the disclosure.

FIG. 5B is a schematic diagram of one side of the midsole structure of the third embodiment in the disclosure.

FIG. 5C is a schematic diagram of a structure unit of the third embodiment in the disclosure.

FIG. 6 is a flowchart of the manufacturing method of the midsole structure in the disclosure.

FIG. 7 is a schematic diagram of a midsole model in the disclosure.

FIG. 8 is a schematic diagram of a 3D lattice model in the disclosure.

FIG. 9A is a schematic diagram of the two-dimensional (2D) mass spring model.

FIG. 9B is a schematic diagram of the 3D mass spring model.

FIG. 10 is a schematic diagram of a midsole model in the disclosure.

FIG. 11 is a schematic diagram of the connection manner of the structure unit in the disclosure.

FIG. 12 is a schematic diagram of the manufacturing process of the manufacturing method of the midsole structure in the disclosure.

### DETAILED DESCRIPTION

The technical contents of this disclosure will become apparent with the detailed description of embodiments accompanied with the illustration of related drawings as follows. It is intended that the embodiments and drawings disclosed herein are to be considered illustrative rather than restrictive.

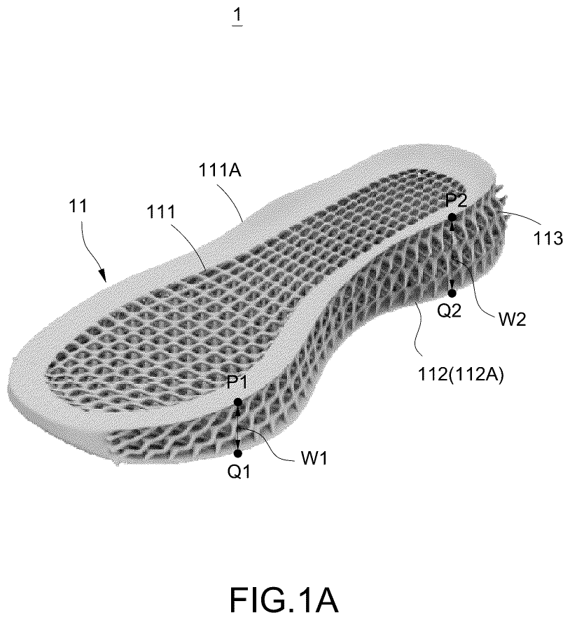

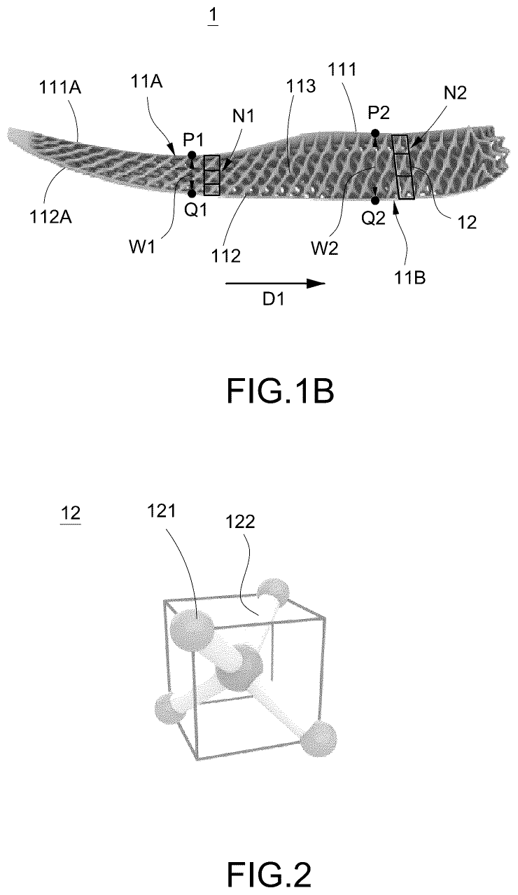

FIG. 1A is a schematic diagram of a midsole structure 1 of the first embodiment in the disclosure. FIG. 1B is a schematic diagram of one side of the midsole structure 1 of the first embodiment in the disclosure.

The midsole structure 1 of the first embodiment in the disclosure may be combined in the shoes product (not shown in figures). The shoes product may be, for example, sports shoes, running shoes, basketball shoes or the other types of shoes. The midsole structure 1 is combined with upper and outsole (not shown in figures) to form the shoes product.

The midsole structure 1 includes a body 11 and a plurality of structure units 12. The body 11 includes a first surface 111, a second surface 112, and a third surface 113. The first surface 111 is enclosed by a first feature line 111A. The second surface 112 is enclosed by a second feature line 112A. The first feature line 111A and the second feature line 112A are non-intersecting to each other (that is, the first feature line 111A and the second feature line 112A are not intersecting). The third surface 113 is located between the first surface 111 and the second surface 112. The third surface 113 is, for example, an annular side surface, and is collectively enclosed by the first feature line 111A and the second feature line 112A. It should be noted that the first feature line 111A is side edge of the first surface 111 (that is, the upper surface, the surface capable of being connected with the shoe body), and the second feature line 112A is side edge of the second surface 112 (that is, the lower surface, the surface capable of being connected with the outsole).

The structure units 12 are disposed among the first surface 111, the second surface 112, and the third surface 113. In other words, the structure units 12 are disposed in the body 11.

FIG. 2 is a schematic diagram of a structure unit 12 of the first embodiment in the disclosure. As shown in FIG. 2, the structure unit 12, for example, has a plurality of particles (or mass points) 121 and a plurality of frames 122 connected between the particles 121. The particles 121 and the frames 122 are structured in a three-dimensional (3D) lattice structure. The 3D lattice structure of each structure unit 12 is formed by eight vertexes (or lattice point, mesh point) of the 3D lattice as the foundation to establish the relative coordinate of each particle 121, and the connection relation between the particles 121 is established by the frames 122. The coordinate of the particle 121 is not limited to eight vertexes, but needs to be located in the 3D space of the 3D lattice. Here uses the structure unit 12 having five particles (four particles located on the vertexes of the 3D lattice, one particle located inside the 3D lattice) and four frames as an example. It should be noted that the numbers of the particle 121 and the frame 122 in each structure unit 12 are not limiting, the number may be different depending on different requirements.

Further, the shapes of the particle 121 and the frame 122 are not limited to sphere and cylinder. The particle 121 and the frame 122 may have different shapes depending on different requirements.

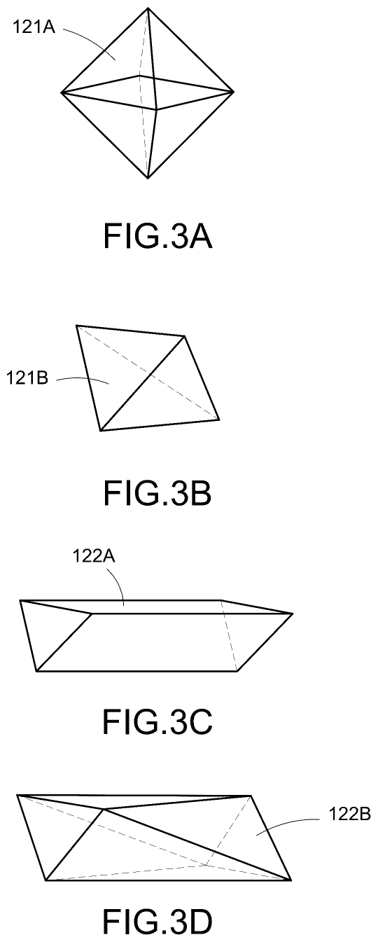

FIG. 3A and FIG. 3B are the schematic diagrams of the particles 121A, 121B of different embodiments in the disclosure. FIG. 3C and FIG. 3D are the schematic diagrams of the frames 122A, 122B of different embodiments in the disclosure. In some embodiments, as shown in FIG. 3A, the shape of the particle 121A may be, for example, an octahedron structured by eight triangles. As shown in FIG. 3B, the shape of the particle 121B may be, for example, a tetrahedron structured by four triangles. The frame may be different prismatoid types depending on the shape of the particles located on two ends. As shown in FIG. 3C, the shape of the frame 122A may be, for example, a triangular prism, or as shown in FIG. 3D, the shape of the frame 122B may also be, for example, an octahedron.

It should be noted that, in the same midsole structure, the shapes of the particles and the frames in all of the structure units are desirably to be set in the same manner. In other words, if the particle is set to be the sphere and the frame is set to be the cylinder, the shapes of the particles and the frames in all of the structure units of the same midsole structure are sphere and cylinder, respectively. On the other hand, in different regions of the same midsole structure, the particles and the frames in the structure units may have different sizes depending on different requirements (for example, the requirement of material stress and strain corresponding to hardness/softness).

Referring back to FIG. 1A and FIG. 1B, in the midsole structure 1, the third surface 113 is increased from a first width W1 to a second width W2 along a direction D1 from a first side 11A of the body 11 (such as the left side in FIG. 1B, that is, the shoe tip side) to a second side 11B of the body 11 (such as the right side in FIG. 1B, that is, the shoe heel side). That is, the third surface 113, such as an annular side surface, has the first width W1 and the second width W2 in different.

On the first side 11A, a first number N1 (for example, a predetermined number) of the structure units 12 are arranged along the first width W1 of the third surface 113. In other words, the structure units 12 are arranged between the first feature line 111A and the second feature line 112A along the first width W1 by the predetermined number.

Specifically, the first feature line 111A may have a first feature point P1, the second feature line 112A may have a second feature point Q1, and the first feature point P1 is corresponding to the second feature point Q1. The first feature point P1 and the second feature point Q1 are distanced by the first width W1. The first number N1 of the structure units 12 are arranged between the first feature point P1 and the second feature point Q1. The first feature point P1 and the second feature point Q1 may be any points on the first feature line 111A and the second feature line 112A defined by the designer, respectively.

On the second side 11B, a second number N2 (for example, the same as the predetermined number) of the structure units 12 are arranged along the second width W2 of the third surface 113. In other words, the structure units 12 are arranged between the first feature line 111A and the second feature line 112A along the second width W2 by the predetermined number. The first number N1 is equal to the second number N2.

Specifically, the first feature line 111A may have a third feature point P2, the second feature line 112A may have a fourth feature point Q2, and the third feature point P2 is corresponding to the fourth feature point Q2. The third feature point P2 and the fourth feature point Q2 are distanced by the second width W2. The second number N2 of the structure units 12 are arranged between the third feature point P2 and the fourth feature point Q2. The third feature point P2 and the fourth feature point Q2 may be any points on the first feature line 111A and the second feature line 112A defined by the designer, respectively. It is worth mentioning that the first number N1 and the second number N2 may be, for example, the predetermined number pre-set by the designer. Here uses that both the first number N1 and the second number N2 are three as an example, here is not intended to be limiting.

Therefore, as shown in FIG. 1B, the 3D lattice structure of each structure unit 12 arranged along the first width W1 is corresponding to the 3D lattice structure of each structure unit 12 arranged along the second width W2. In other words, if the structure units 12 arranged along the first width W1 are three complete 3D lattice structure, the structure units 12 arranged along the second width W2 are also three complete 3D lattice structure correspondingly.

On the other hand, the stable state of the structure units 12 arranged along the first width W1 may be different from the stable state of the structure units 12 arranged along the second width W2. The stable state here indicates that the 3D lattice structure of the structure unit 12 is dynamically under a stable status. In other words, the structure units 12 arranged along the first width W1 (that is, the first side 11A) may need to be arranged in a more compact structure comparing to the structure units 12 arranged along the second width W2 (that is, the first side 11B), and thus the 3D lattice structure of the structure units 12 arranged along the first width W1 may be in a compact stable state and the 3D lattice structure of the structure units 12 arranged along the second width W2 may be in a loose or relaxed stable state.

In summary, the midsole structure 1 of the embodiment is disposing the same layers of structure units 12 at all locations in the midsole structure 1. In other words, viewing the annular side surface of the midsole structure 1 from any sides (front side, middle side or back side), on the width direction at any locations, the structure units 12 are arranged with the same number. As a result, the whole structural strength being influenced by the incomplete structure unit 12 may be prevented, and thus the structural strength of the midsole structure 1 may be increased.

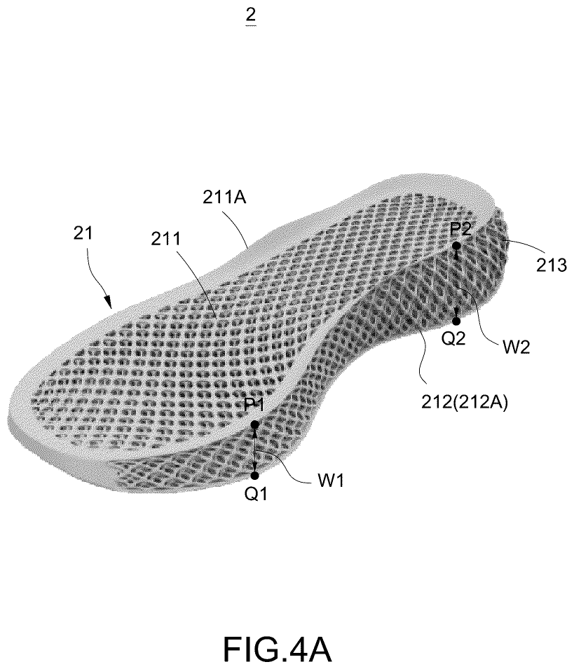

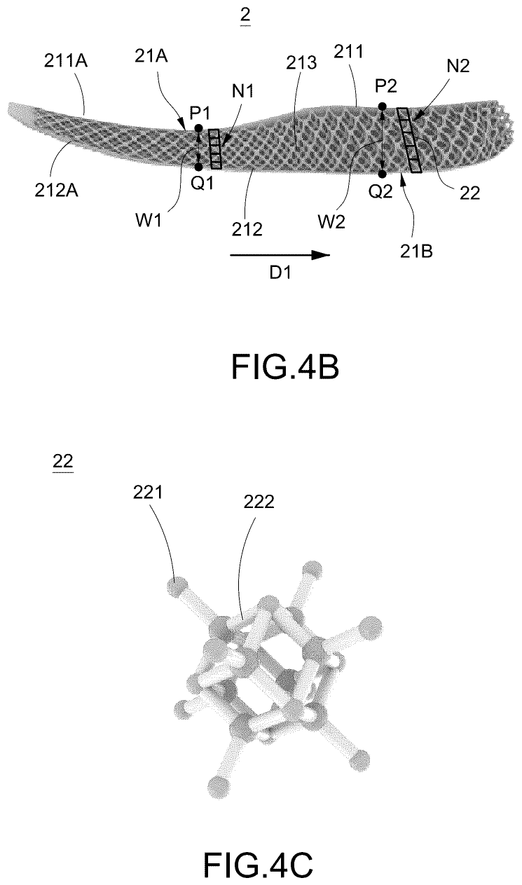

FIG. 4A is a schematic diagram of a midsole structure 2 of the second embodiment in the disclosure. FIG. 4B is a schematic diagram of one side of the midsole structure 2 of the second embodiment in the disclosure. FIG. 4C is a schematic diagram of a structure unit 22 of the second embodiment in the disclosure.

The midsole structure 2 of the embodiment also includes the body 21 and a plurality of structure units 22. The differences between the midsole structure 2 of the embodiment and the aforementioned midsole structure 1 are that the numbers of the particles 221 and the frames 222 connected between the particles 221 in the structure unit 22 are different, and the 3D lattice structure formed by the particles 221 and the frames 222 is different.

Specifically, here uses the structure unit 12 (as shown in FIG. 2) as the foundation unit of the structure unit 22 and combines eight structure units 12 as an example. In other words, the structure unit 22 is approximately formed by sharing and combining three particles located at the vertexes of the 3D lattice in each one of eight structure units 12. Similarly, the 3D lattice structure of each structure unit 22 is formed by eight vertexes of the 3D lattice as the foundation to establish the relative coordinate of each particle 221, and the connection relation between the particles 221 is established by the frames 222.

Similarly, the shapes of the particle 221 and the frame 222 are not limited to sphere and cylinder. The particle 221 and the frame 222 may have different shapes depending on different requirements.

In the midsole structure 2, the third surface 213 is increased from a first width W1 to a second width W2 along a direction D1 from a first side 21A of the body 21 (such as the left side in FIG. 4B, that is, the shoe tip side) to a second side 21B of the body 21 (such as the right side in FIG. 4B, that is, the shoe heel side). That is, the third surface 213, such as the annular side surface, has the first width W1 and the second width W2 in different.

On the first side 21A, the first number N1 (for example, the predetermined number) of the structure units 22 are arranged along the first width W1 of the third surface 213. In other words, the structure units 22 are arranged between the first feature line 211A and the second feature line 212A along the first width W1 by the predetermined number.

On the second side 21B, the second number N2 (for example, the same as the predetermined number) of the structure units 22 are arranged along the second width W2 of the third surface 213. In other words, the structure units 22 are arranged between the first feature line 211A and the second feature line 212A along the second width W2 by the predetermined number. The first number N1 is equal to the second number N2. Here uses that both the first number N1 and the second number N2 are five as an example, here is not intended to be limiting.

Therefore, as shown in FIG. 4B, the 3D lattice structure of each structure unit 22 arranged along the first width W1 is corresponding to the 3D lattice structure of each structure unit 22 arranged along the second width W2. In other words, if the structure units 22 arranged along the first width W1 are five complete 3D lattice structure, the structure units 22 arranged along the second width W2 are also five complete 3D lattice structure correspondingly.

On the other hand, the structure units 22 arranged along the first width W1 (that is, the first side 21A) may need to be arranged in a more compact structure comparing to the structure units 22 arranged along the second width W2 (that is, the first side 21B), and thus the 3D lattice structure of the structure units 22 arranged along the first width W1 may be in a compact stable state and the 3D lattice structure of the structure units 22 arranged along the second width W2 may be in a loose or relaxed stable state.

In summary, viewing the annular side surface of the midsole structure 2 of the embodiment from any sides (front side, middle side or back side), on the width direction at any locations, the structure units 22 are arranged with the same number. As a result, the whole structural strength being influenced by the incomplete structure unit 22 may be prevented, and thus the structural strength of the midsole structure 2 may be increased. Further, the structure unit 22 may have different structural performance by different 3D lattice structure, thereby increasing the applying range of the midsole structure 2 in the disclosure.

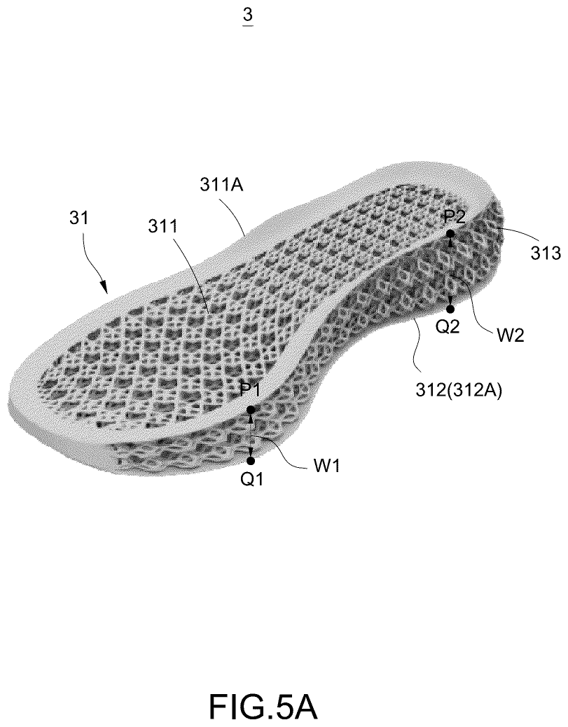

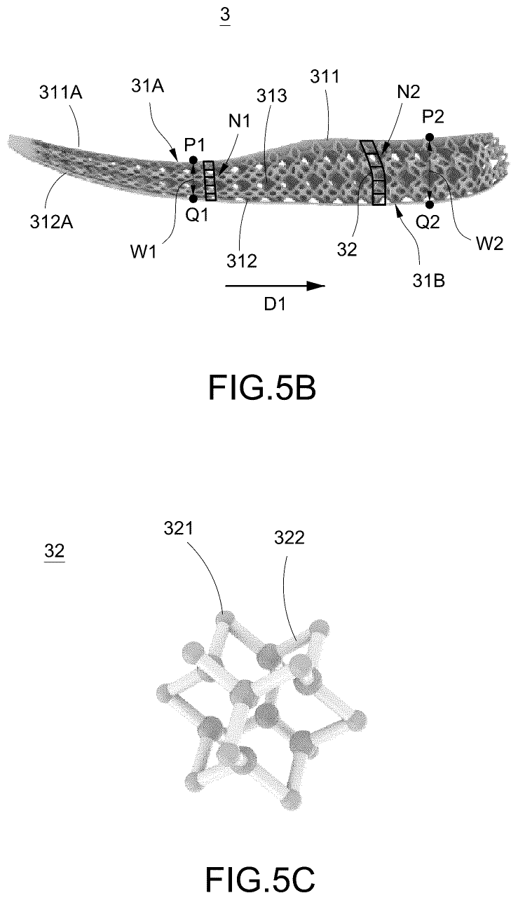

FIG. 5A is a schematic diagram of a midsole structure 3 of the third embodiment in the disclosure. FIG. 5B is a schematic diagram of one side of the midsole structure 3 of the third embodiment in the disclosure. FIG. 5C is a schematic diagram of a structure unit 32 of the third embodiment in the disclosure.

The midsole structure 3 of the embodiment also includes the body 31 and a plurality of structure units 32. The differences between the midsole structure 3 of the embodiment and the aforementioned midsole structure 1 are that the numbers of the particles 321 and the frames 322 connected between the particles 321 in the structure unit 32 are different, and the 3D lattice structure formed by the particles 321 and the frames 322 is different.

Specifically, here uses the structure unit 12 (as shown in FIG. 2) eliminated by one particle (that is, the structure in a manner of three particles located on the vertexes of the 3D lattice and one particle located inside the 3D lattice) and one frame as the foundation structure unit of the structure unit 32 and combines eight foundation structure units as an example. In other words, the structure unit 32 is approximately formed by sharing and combining three particles located at the vertexes of the 3D lattice in each one of foundation structure units. Similarly, the 3D lattice structure of each structure unit 32 is formed by eight vertexes of the 3D lattice as the foundation to establish the relative coordinate of each particle 321, and the connection relation between the particles 321 is established by the frames 322.

Similarly, the shapes of the particle 321 and the frame 322 are not limited to sphere and cylinder. The particle 321 and the frame 322 may have different shapes depending on different requirements.

In the midsole structure 3, the third surface 313 is increased from a first width W1 to a second width W2 along a direction D1 from a first side 31A of the body 31 (such as the left side in FIG. 5B, that is, the shoe tip side) to a second side 31B of the body 31 (such as the right side in FIG. 5B, that is, the shoe heel side). That is, the third surface 313, such as the annular side surface, has the first width W1 and the second width W2 in different.

On the first side 31A, the first number N1 (for example, the predetermined number) of the structure units 32 are arranged along the first width W1 of the third surface 313. In other words, the structure units 32 are arranged between the first feature line 311A and the second feature line 312A along the first width W1 by the predetermined number.

On the second side 31B, the second number N2 (for example, the same as the predetermined number) of the structure units 32 are arranged along the second width W2 of the third surface 313. In other words, the structure units 32 are arranged between the first feature line 311A and the second feature line 312A along the second width W2 by the predetermined number. The first number N1 is equal to the second number N2. Here uses that both the first number N1 and the second number N2 are five as an example, here is not intended to be limiting.

Therefore, as shown in FIG. 5B, the 3D lattice structure of each structure unit 32 arranged along the first width W1 is corresponding to the 3D lattice structure of each structure unit 32 arranged along the second width W2. In other words, if the structure units 32 arranged along the first width W1 are five complete 3D lattice structure, the structure units 32 arranged along the second width W2 are also five complete 3D lattice structure correspondingly.

On the other hand, the structure units 32 arranged along the first width W1 (that is, the first side 31A) may need to be arranged in a more compact structure comparing to the structure units 32 arranged along the second width W2 (that is, the first side 31B), and thus the 3D lattice structure of the structure units 32 arranged along the first width W1 may be in a compact stable state and the 3D lattice structure of the structure units 32 arranged along the second width W2 may be in a loose or relaxed stable state.

In summary, viewing the annular side surface of the midsole structure 3 of the embodiment from any sides (front side, middle side or back side), on the width direction at any locations, the structure units 32 are arranged with the same number. As a result, the whole structural strength being influenced by the incomplete structure unit 32 may be prevented, and thus the structural strength of the midsole structure 3 may be increased. Further, the structure unit 32 may have different structural performance by different 3D lattice structure, thereby increasing the applying range of the midsole structure 3 in the disclosure.

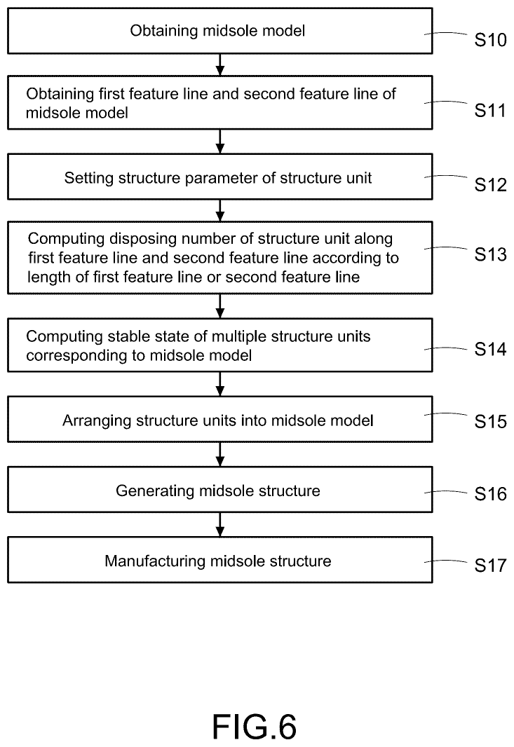

FIG. 6 is a flowchart of the manufacturing method of the midsole structure in the disclosure. The manufacturing method of the midsole structure in the disclosure includes the step S10 to the step S17. The manufacturing method of the midsole structure in the disclosure is, for example, performed by the computer executing the program in the computer readable medium. The step S10 is obtaining a midsole model. The step S11 is obtaining a first feature line and a second feature line of the midsole model. The step S12 is setting a structure parameter of a structure unit. The step S13 is computing a disposing number of the structure unit along the first feature line and the second feature line according to a length of the first feature line or the second feature line. The step S14 is computing a stable state of a plurality of structure units corresponding to the midsole model. The step S15 is arranging the structure units into the midsole model. The step S16 is generating the midsole structure. The step S17 is manufacturing the midsole structure.

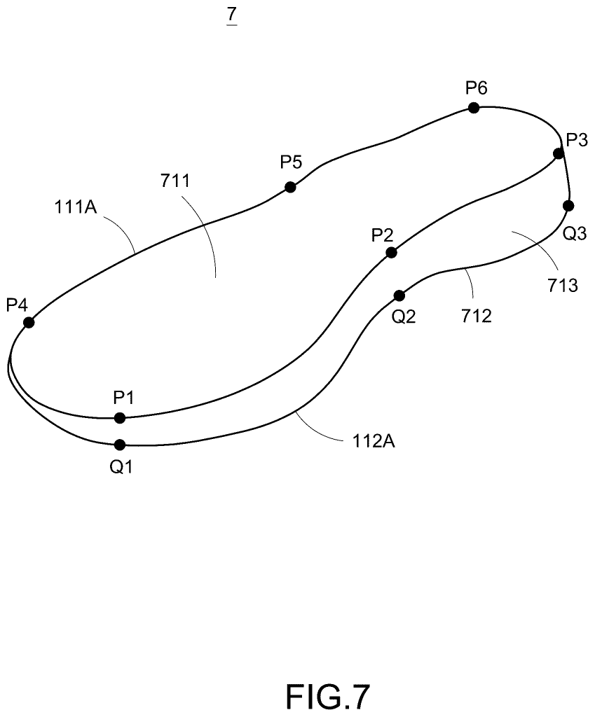

FIG. 7 is a schematic diagram of a midsole model in the disclosure. Referring to FIG. 6 and FIG. 7, in the step S10, the midsole model 7 is obtained. In the step S11, the first feature line 111A and the second feature line 112A of the midsole model 7 are obtained.

The 3D midsole model 7 is structured by points and triangle meshes. The midsole model 7 may be, for example, a predetermined midsole model stored in the database, or a midsole model obtained from modelling a user's foot shape. After computing the normal vectors of the triangle meshes (not shown in figures), the triangle meshes of the whole 3D midsole model 7 may be divided into three grids with different directional regions (that is, the first surface 711, the second surface 712 and the third surface 713) by determining the continuity of connected triangle meshes with respect to the included angle of the normal vectors. The divisional lines are the first feature line 111A and the second feature line 112A of the midsole model 7. In other words, the first feature line 111A of the midsole model 7 is side edge of the first surface 711 (that is, the upper surface, the surface capable of being connected with the shoe body), and the second feature line 112A of the midsole model 7 is side edge of the second surface 712 (that is, the lower surface, the surface capable of being connected with the outsole).

The first feature line 111A and the second feature line 112A are two similar profile curves, and six feature points P1˜P6, Q1˜Q6 (Q4˜Q6 are located on inner side of the figure, not shown in figures) may respectively be defined as the fixed points on the front proportional sections, the middle proportional sections, and the rear proportional sections of the first feature line 111A and the second feature line 112A. Next, the sectional lengths of the first feature line 111A and the second feature line 112A divided by the six feature points P1˜P6, Q1˜Q6 are computed. Finally, the pairing relations of the feature points on the first feature line 111A and the second feature line 112A are established, such as P1 is paired with Q1, P2 is paired with Q2, etc.

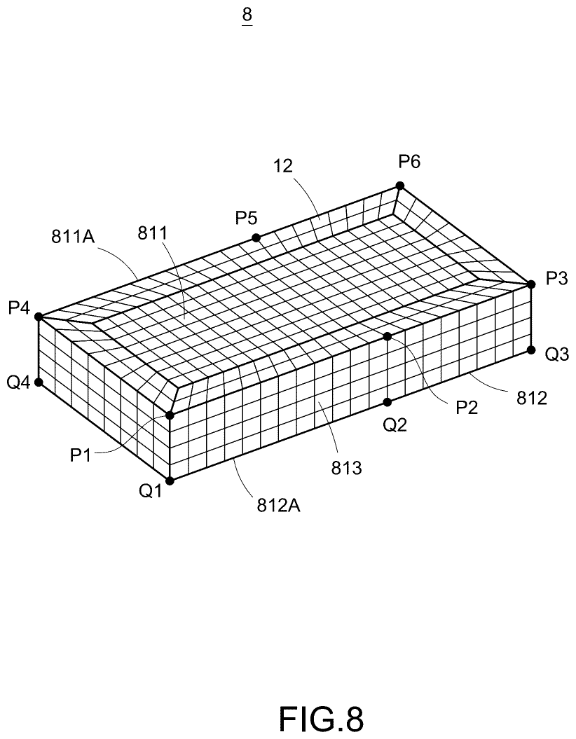

FIG. 8 is a schematic diagram of a 3D lattice model 8 in the disclosure. Referring to FIG. 6 to FIG. 8, in the step S12, the structure parameter of the structure unit 12 is set. In the step S13, the disposing number of the structure units 12 along the first feature line 111A and the second feature line 112A is computed according to a length of the first feature line 111A or the second feature line 112A.

The designer may set the structure parameter of the structure unit 12, for example, the size, the filling layer number, etc., of the structure unit 12. The system program is configured to prepare the defined 3D lattice model 8 in a manner of outer-ring-inner-mesh according to the size and filling layer number of the structure unit 12 set by the designer. Each structure unit 12 is a hexahedron formed with eight vertexes. The number of the structure units 12 on length direction and width direction may be obtained by computing the sectional lengths of the first feature line 111A and the second feature line 112A, and the size of the structure unit 12. If the numbers of the structure units 12 at the same section on the first feature line 111A and the second feature line 112A are different, the greater one is used as datum, and the number may be modified in the following steps.

Therefore, in the 3D lattice model 8, the first feature line 811A and the second feature line 812A may be defined, and twelve feature points P1˜P6, Q1˜Q6 (Q5˜Q6 are located on inner side of the figure, not shown in figures) may also be defined as the fixed points. Further, the whole 3D lattice model 8 may be divided into three grids (that is, the first surface 811, the second surface 812 and the third surface 813). As a result, that may be related to the information obtained in the step S11. In other words, twelve feature points P1˜P6, Q1˜Q6 of the 3D lattice model 8 corresponding to those of the midsole model 7 are fitted to the midsole model 7, and the lattice points of the structure units 12 at each section on the first feature line 811A and the second feature line 812A are sequentially and equidistantly arranged to the first feature line 111A and the second feature line 112A in the midsole model 7.

It should be noted that the 3D lattice model 8 in FIG. 8 may be a virtual structure in the system program and non-displayed to the designer.

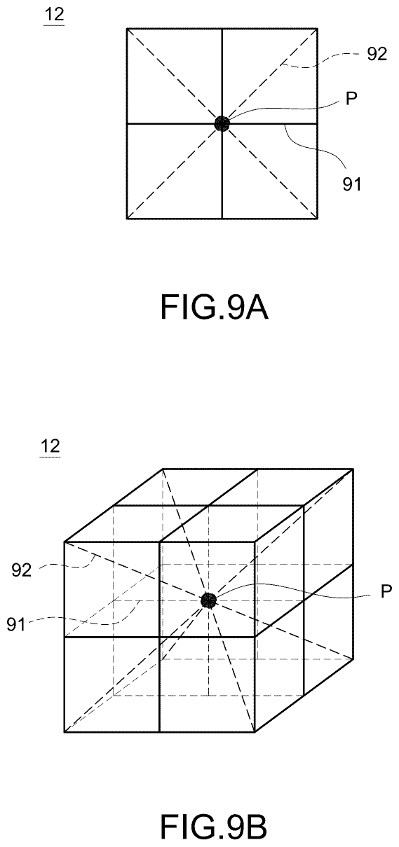

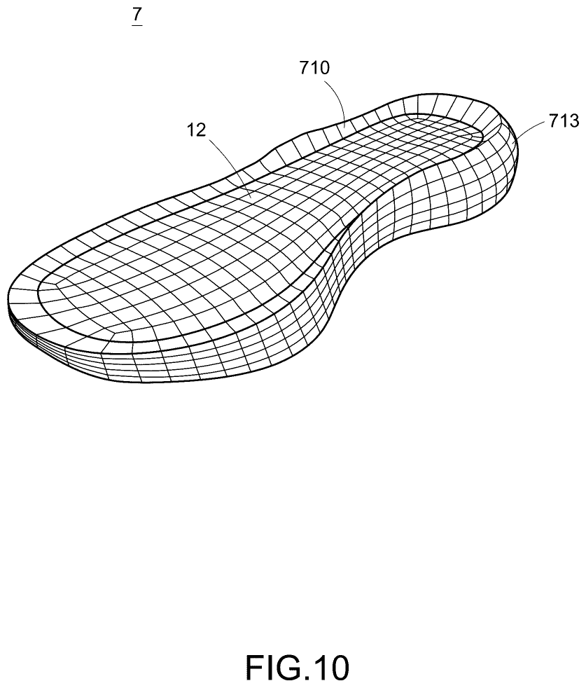

FIG. 9A is a schematic diagram of the 2D mass spring model. FIG. 9B is a schematic diagram of the 3D mass spring model. FIG. 10 is a schematic diagram of a midsole model 7 in the disclosure.

Referring to FIG. 6, FIG. 8, FIG. 9A, FIG. 9B, and FIG. 10, in the step S14, the stable state of a plurality of structure units 12 corresponding to the midsole model 7 are computed. In some embodiments, the computing of the stable state of the structure units 12 corresponding to the midsole model 7 further includes: computing a planar stable state of the structure units 12 corresponding to a first surface 711, a second surface 712, and a third surface 713 located between the first surface 711 and the second surface 712 of the midsole model 7; and computing a 3D stable state of the structure units 12 corresponding to the midsole model 7.

In order to dispose the 3D lattice model 8 (as shown in FIG. 8) into the 3D midsole model 7, finite element method may be used to perform numerical modelling. 2D mass-spring model and 3D mass-spring model may be used to establish the relation between the vertexes of each 3D structure unit 12. 2D mass-spring model is mainly used for surface vertex simulation of the 3D lattice model 8 (as shown in FIG. 9A), and 3D mass-spring model is used to simulate the inner structure of the 3D lattice model 8 (as shown in FIG. 9B). In the mass-spring model, each grid point P is connected to the adjacent point on the same axis by structural spring 91, and is connected to the adjacent point on the different axis by sheer spring 92. That may make the grid points P keep distance and maintain original grid structure during iterative calculation process of numerical modelling.

First, the grid points on the first surface 811, the second surface 812 and the third surface 813 of the 3D lattice model 8 are projected to the first surface 711, the second surface 712, and the third surface 713 of the corresponding midsole model 7 using the feature points P1˜P6, Q1˜Q6 of the first feature line 811A and the second feature line 812A as boundary conditions, and numerical modelling is performed using finite element method based on 2D mass-spring model to compute the coordinate under the stable state.

Next, with respect to the grid points inside the midsole model 7, which are not disposed yet, numerical modelling is performed using finite element method based on 3D mass-spring model to compute the coordinate under the stable state. As shown in FIG. 10, when the iterative calculation is converged, the process of disposing the 3D lattice model into the midsole model 7 is completed. The whole lattice model is arranged in a manner of outer-ring-inner-mesh.

In some embodiments, the computing of the 3D stable state of the structure units 12 corresponding to the midsole model 7 further includes: deforming the structure units 12 on the third surface 713. The regular arrangement of the 3D lattice model may be modified (or morphed) to have various designations depending on designing requirement. For example, the third surface 713 of the midsole model 7 may have foaming effect.

Referring to FIG. 1A, FIG. 1B, FIG. 2, and FIG. 6, in the step S15, the structure units 12 are arranged into the midsole model 7 (as shown in FIG. 7). In the step S16, the midsole structure 1 is generated. In the step S17, the midsole structure 1 manufactured. In some embodiments, the arranging of the structure units 12 into the midsole model 7 further includes: arranging the structure units 12 into the midsole model 7 according to the planar stable state and the 3D stable state.

It should be noted that the manufacturing method of the midsole structure of the disclosure may also be applied to the midsole structures in FIG. 4A to FIG. 4C or FIG. 5A to FIG. 5C, or the midsole structure having the other different structure units.

Similar to the description in FIG. 1A, FIG. 1B, and FIG. 2, the 3D lattice structure of each structure unit 12 is formed by eight vertexes of the 3D lattice as the foundation to establish the relative coordinate of each particle 121, and the connection relation between the particles 121 is established by the frames 122. The coordinate of the particle 121 is not limited to eight vertexes, but needs to be in 3D space of the 3D lattice. Various 3D lattice structures (such as FIG. 2, FIG. 4C and FIG. 5C) may be generated through the connection relation of the particles 121 and the frames 122 in different numbers, and may render different structural behaviors in force simulation of the mass-spring model as shown in FIG. 9A and FIG. 9B. Moreover, the midsole structure 1 with different material stress and strain performances may be obtained with respect to different sizes of the particles 121 and the frames 122.

When the related parameters of the 3D lattice structure of the whole midsole model 7 are simulated, the midsole structure 1 may be generated according to the coordinates of the particles 121 and the connecting frames 122, and the midsole structure 1 may be manufactured.

In some embodiments, the midsole structure 1 may be manufactured by 3D printing. 3D printing may be corresponding to the following 3D printing technology types: extrusion type, metal wire type, particle type, powder bed and inkjet head type, lamination type, and photopolymerization type. Further, the extrusion type may include fused deposition modeling (FDM) and fused filament modeling (FFF). The metal wire type may include electron-beam freeform fabrication (EBF). The particle type may include direct metal laser sintering (DMLS), electron-beam melting (EBM), selective laser melting (SLM), selective heat sintering (SHS), and selective laser sintering (SLS). The powder bed and inkjet head type include plaster-based 3D printing (PP). the lamination type may include laminated object manufacturing (LOM). The photopolymerization type may include stereolithography (SLA) and digital light processing (DLP). Here is not intended to be limiting.

It is worth mentioning that the grid of the midsole structure 1 may be further segmented by curved surface to re-generate completely smooth appearance of the 3D midsole structure 1 for 3D printing performance with better quality. Moreover, the process of the manufacturing method of the disclosure is not limited the aforementioned embodiment, different process may be used depending on different requirements. For example, the step S12 may be re-executed after the step S13 or the step S14.

It should be noted that, before 3D printing the midsole structure 1, feasibility of printing the midsole structure 1 and manufacturing shoes product needs to be considered. The main consideration is that the midsole structure 1 needs to be capable of gluing or bonding with upper and outsole, and the midsole structure 1 may discharge glue during 3D printing with light curing process.

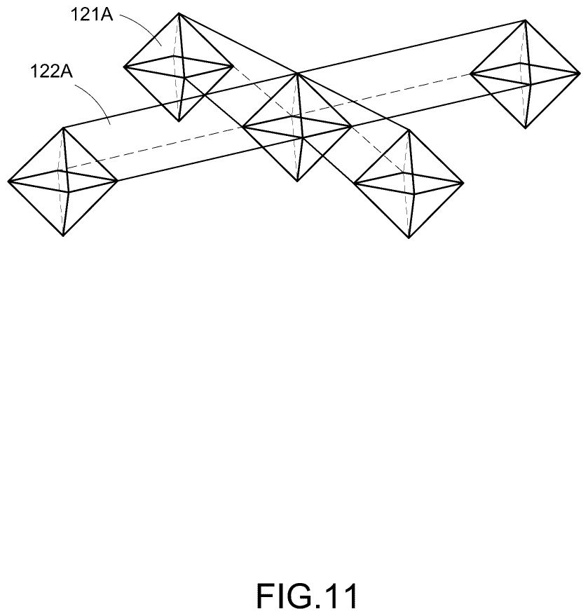

FIG. 11 is a schematic diagram of the connection manner of the structure unit in the disclosure. As shown in FIG. 11, with respect to the aforementioned consideration, the disclosure may establish the connection of the frames 122A on lateral direction in the uppermost and bottommost 3D lattice structure of the midsole structure. It should be noted that the shape of the particle 121A uses octahedron formed by eight triangles and the shape of the frame 122A uses triangular prism as an example, here is not intended to be limiting.

Further, the structure units located on the outer ring of the uppermost layer and bottommost layer may be created to be a thin frame (such as the outer ring potion 710 in FIG. 10). The thickness of the thin frame may be obtained by deforming the size of the structure units after setting the parameters according to requirement. It is worth mentioning that the hollow-out thin shell on upper layer and lower layer of the midsole structure may facilitate the discharging of glue during 3D printing and the gluing with upper and outsole during manufacturing the shoes product.

In summary, the manufacturing method of the midsole structure of the disclosure are disposing the structure units into the midsole structure after computing the stable state of the structure units corresponding to the midsole model. In other words, the designer may set the structure parameters of the structure units on different regions in advance with respect to different designing requirement, and arrange the structure units into the midsole structure after computing the stable state of the structure units by software. Therefore, the manufacturing method of the midsole structure of the disclosure may simplify the designation and shorten the development schedule.

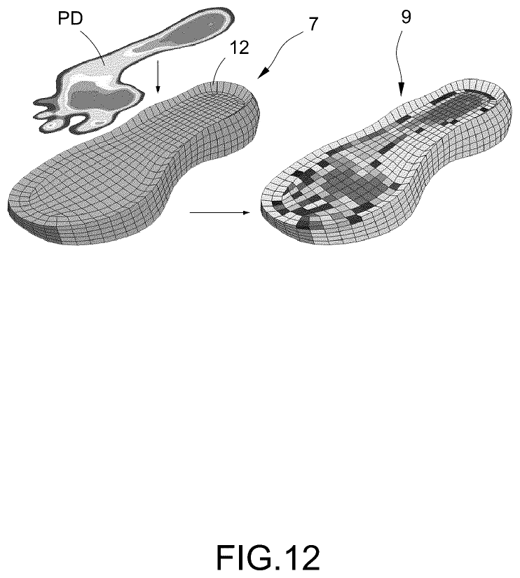

FIG. 12 is a schematic diagram of the manufacturing process of the manufacturing method of the midsole structure in the disclosure. In some embodiments, the generating of the midsole structure further includes: modifying a plurality of structure parameters of the structure units 12 according to a pressure distribution PD.

In some embodiments, the disclosure may be configured to designate the pressure value of each structure unit 12 according to the pressure distribution PD. As a result, the particles 12 of each structure unit 12 may have corresponding sizes according to the pressure value that the particle 12 is located. Therefore, the pressure distribution PD of the user's sole may be directly projected to the whole midsole model 7. The midsole model 7 may be applied with the pressure values indicated by the pressure distribution PD. Deep color indicates that the structural strength needs to be softer (for example, the smallest size of the particle), and light color indicates that the structural strength needs to be harder (for example, the largest size of the particle). Thus, the midsole structure 9 may have different hardness/softness on different regions to achieve the purpose of generating customized midsole structure 9.

In summary, the midsole structure and the manufacturing method thereof of the disclosure are disposing the same layers of structure units at all locations in the midsole structure. In other words, viewing the annular side surface of the midsole structure from any sides (front side, middle side or back side), on the width direction at any locations, the structure units are arranged with the same number. As a result, the whole structural strength being influenced by the incomplete structure unit may be prevented, and thus the structural strength of the midsole structure may be increased. Further, the midsole structure and the manufacturing method thereof of the disclosure are disposing the structure units into the midsole structure after computing the stable state of the structure units corresponding to the midsole model. In other words, the designer may set the structure parameters of the structure units on different regions in advance with respect to different designing requirement, and arrange the structure units into the midsole structure after computing the stable state of the structure units by software. Therefore, the midsole structure and the manufacturing method thereof of the disclosure may simplify the designation and shorten the development schedule. Further, the midsole structure and the manufacturing method thereof of the disclosure may have different hardness/softness on different regions to achieve the purpose of generating customized midsole structure.

While this disclosure has been described by means of specific embodiments, numerous modifications and variations may be made thereto by those skilled in the art without departing from the scope and spirit of this disclosure set forth in the claims.

What is claimed is:

1. A midsole structure, combined in a shoes product, the midsole structure comprising:
a body, comprising:
a first surface, enclosed by a first feature line;
a second surface, enclosed by a second feature line; and
a third surface, located between the first surface and the second surface, and collectively enclosed by the first feature line and the second feature line; and
a plurality of structure units, disposed among the first surface, the second surface, and the third surface,
wherein the third surface is increased from a first width to a second width along a direction from a first side of the body to a second side of the body,
on the first side, a first number of the structure units are arranged along the first width of the third surface,
on the second side, a second number of the structure units are arranged along the second width of the third surface,
the first number is equal to the second number.

2. The midsole structure according to claim 1, wherein the first feature line comprises a first feature point, the second feature line comprises a second feature point, the first feature point is corresponding to the second feature point, and the first feature point and the second feature point are distanced by the first width,
the first number of the structure units are arranged between the first feature point and the second feature point.

3. The midsole structure according to claim 2, wherein the first feature line comprises a third feature point, the second feature line comprises a fourth feature point, the third feature point is corresponding to the fourth feature point, and the third feature point and the fourth feature point are distanced by the second width,
the second number of the structure units are arranged between the third feature point and the fourth feature point.

4. The midsole structure according to claim 1, wherein each structure unit comprises a plurality of particles and a plurality of frames connected between the particles, the particles and the frames are structured in a three-dimensional (3D) lattice structure.

5. The midsole structure according to claim 4, wherein the 3D lattice structure of each structure unit arranged along the first width is corresponding to the 3D lattice structure of each structure unit arranged along the second width.

6. The midsole structure according to claim 4, wherein each particle is a sphere, an octahedron, or a tetrahedron.

7. The midsole structure according to claim 1, wherein a stable state of the structure units arranged along the first width is different from a stable state of the structure units arranged along the second width.

8. A midsole structure, combined in a shoes product, the midsole structure comprising:
a body, comprising a first feature line and a second feature non-intersecting to each other, and an annular side surface collectively enclosed by the first feature line and the second feature line; and
a plurality of structure units, disposed in the body,
wherein the annular side surface comprises a first width and a second width, the first width is different from the second width,
the structure units are arranged between the first feature line and the second feature line along the first width by a predetermined number, and the structure units are arranged between the first feature line and the second feature line along the second width by the predetermined number.

9. The midsole structure according to claim 8, wherein the first feature line comprises a first feature point, the second feature line comprises a second feature point, the first feature point is corresponding to the second feature point, and the first feature point and the second feature point are distanced by the first width,
the predetermined number of the structure units are arranged between the first feature point and the second feature point.

10. The midsole structure according to claim 9, wherein the first feature line comprises a third feature point, the second feature line comprises a fourth feature point, the third feature point is corresponding to the fourth feature point, and the third feature point and the fourth feature point are distanced by the second width,
the predetermined number of the structure units are arranged between the third feature point and the fourth feature point.

11. The midsole structure according to claim 8, wherein each structure unit comprises a plurality of particles and a plurality of frames connected between the particles, the particles and the frames are structured in a three-dimensional (3D) lattice structure.

12. The midsole structure according to claim 11, wherein the 3D lattice structure of each structure unit arranged along the first width is corresponding to the 3D lattice structure of each structure unit arranged along the second width.

13. The midsole structure according to claim 8, wherein a stable state of the structure units arranged along the first width is different from a stable state of the structure units arranged along the second width.

14. A manufacturing method of a midsole structure, the manufacturing method comprising:
obtaining a midsole model;
obtaining a first feature line and a second feature line of the midsole model;
setting a structure parameter of a structure unit;
computing a disposing number of the structure unit along the first feature line and the second feature line according to a length of the first feature line or the second feature line;
computing a stable state of a plurality of structure units corresponding to the midsole model;
arranging the structure units into the midsole model;
generating the midsole structure; and
manufacturing the midsole structure.

15. The manufacturing method according to claim 14, wherein the computing of the stable state of the structure units corresponding to the midsole model further comprises:
computing a planar stable state of the structure units corresponding to a first surface, a second surface, and a third surface located between the first surface and the second surface of the midsole model.

16. The manufacturing method according to claim 15, wherein the computing of the stable state of the structure units corresponding to the midsole model further comprises:
computing a three dimensional (3D) stable state of the structure units corresponding to the midsole model.

17. The manufacturing method according to claim 16, wherein the arranging of the structure units into the midsole model further comprises:
arranging the structure units into the midsole model according to the planar stable state and the 3D stable state.

18. The manufacturing method according to claim 17, wherein the computing of the 3D stable state of the structure units corresponding to the midsole model further comprises:
deforming the structure units on the third surface.

19. The manufacturing method according to claim 14, wherein the generating of the midsole structure further comprises:
modifying a plurality of structure parameters of the structure units according to a pressure distribution.

20. The manufacturing method according to claim 14, wherein the manufacturing of the midsole structure further comprises:
manufacturing, by 3D printing, the midsole structure.
